(19) United States
(12) Patent Application Publication
(10) Pub. No.: US 2011/0056205 A1
(43) Pub. Date: Mar. 10, 2011

(54) BURNER ARRANGEMENT AND USE OF SAME

(75) Inventors: Richard CARRONI, Niederrohrdorf (CH); Alexander NI, Baden (CH)

(73) Assignee: ALSTOM TECHNOLOGY LTD, Baden (CH)

(21) Appl. No.: 12/876,687

(22) Filed: Sep. 7, 2010

Related U.S. Application Data
(63) Continuation of application No. PCT/EP2009/051632, filed on Feb. 12, 2009.

(30) Foreign Application Priority Data
Mar. 7, 2008 (CH) 00348/08

(51) Int. Cl. F02C 1/00; F23D 14/62

(52) U.S. Cl. 60/737; 431/354

(57) ABSTRACT

A burner arrangement is provided including a swirl-generating premix burner for providing a fuel/air mixture produced with a first fuel as well as a mixing pipe adjoining the premix burner downstream thereof and extending into a combustion chamber. In the case of such a burner arrangement, safer operation with highly reactive, in particular H₂-rich fuel is achieved by the mixing pipe having a constriction downstream of the outlet of the swirl generator, and by a feeder for spraying in the highly reactive, in particular H₂-rich fuel being arranged at the level of the constriction.

### CROSS REFERENCE TO RELATED APPLICATION

This application is a continuation of International Application No. PCT/EP2009/051632 filed Feb. 12, 2009, which claims priority to Swiss Patent Application No. 00348/08, filed Mar. 7, 2008, the entire contents of all of which are incorporated by reference as if fully set forth.

### FIELD OF INVENTION

The present invention relates to the field of combustion technology, particularly, a burner arrangement.

### BACKGROUND

The prior art has long disclosed burner arrangements which, as shown in FIG. 1, comprise along a burner axis 15 a premix burner 11, in the form of a double cone burner, producing an air/fuel mixture 12, and a following mixing pipe 13, extending into a combustion chamber 14 (EP0704657-A2, EP0913630-A1, U.S. Pat. No. 6,045,351, WO2006/069861). These known burner arrangements 10, referred to as AEV burners, are designed for burning natural gas and/or oil, but are not suitable for burning highly reactive fuels, in particular fuels with a high H₂ content, because a flashback can occur from the combustion chamber into the interior of the premix burner. Therefore, modifications in which the entire H₂-rich fuel is sprayed in through holes in the shells of the premix burner 11 have already been proposed. This makes it possible to burn high concentrations of hydrogen. Conversely, however, a high degree of rarefaction is necessary for this. In addition, it has been the case that a flashback occurs as soon as the air temperature rises above 460° C., which rules out the safe burning of H₂-rich fuels in gas turbines, this applying to all gas turbines whether or not they are equipped with a combustion chamber or with sequential combustion. However, axially graduated spraying in of the fuel is also conceivable, part of the fuel being injected by way of the segment forming the premix burner and the rest being sprayed into the mixing pipe.

It has also been proposed to spray in H₂-rich fuels in a transitional portion, which serves for transferring a flow formed upstream, between the swirl generator and the mixing pipe. Recent investigations have found that safety can be increased if the greater proportion of the fuel is sprayed in downstream of this transitional portion, i.e. within the mixing pipe. The experimental data and following considerations concerning the refinement of the burner arrangement indicate that very high fuel injection rates are necessary in order to ensure that the fuel does not remain attached to the walls of the mixing pipe or diffuse in there. The introduction particularly of a highly reactive fuel in the direct vicinity of the inner walls of the mixing pipe must be avoided under any circumstances, in particular when fuels with a high H₂ content are concerned, because otherwise flashback is indeed encouraged. Internal investigations suggest the finding that the mixing pipe of a premix burner can be changed over from a cylindrical shape to a conically narrowing configuration in order to achieve the following:
An increase in the burner speed upstream of the central flowback zone at the burner outlet, in order to reduce the probability of a flashback.
A reduction in the intensity of the central flowback zone at the burner outlet, in order to reduce the probability of a flashback.
A displacement of the central flowback zone further downstream, in order to reduce the probability of a flashback.
Prevention of the propagation of shock waves caused by pressure and mass perturbations when introducing the combustion air and/or the fuels into the premix burner, and thus reducing the probability of a flashback.

These measures are suitable in particular for operation with a conventional gaseous fuel. With regard to H₂-rich fuels, on the other hand, there is the concern that, in the case of ignition commencing upstream of the nozzle throat, the flame front would be firmly anchored within the premix burner, the combustion air flow then no longer being capable of moving this flame front rapidly downstream outside the premix burner.

It has become known in a different context from WO2004/071637A1, for mixing two media, in particular air and a fuel, to use a mixing device which has, one after the other in the direction of flow, a converging portion, a throat and a diverging portion, with a swirl generator being arranged upstream of the converging portion and the second medium (fuel) being sprayed into the converging portion itself or upstream thereof.

### SUMMARY

The present disclosure is directed to a burner arrangement for operating a premix burner for at least one fuel. The premix burner includes a swirl generator or is equipped with a swirl generator at a head portion of the premix burner, a fuel feeder and combustion air stream feeder, at least into the swirl generator. The burner arrangement includes at least one mixing pipe which extends into a combustion chamber acting downstream of the premix burner or swirl generator. The mixing pipe has, downstream of the swirl generator associated with the premix burner, a cross-sectional constriction, and a fuel feeder for spraying in a highly reactive fuel arranged in the region of the constriction.

The present disclosure is also directed to a use of the above burner arrangement in a gas turbine installation that can be operated with at least one combustion chamber

### BRIEF DESCRIPTION OF THE DRAWINGS

In the figures:

FIG. 1 shows in a greatly schematized representation a burner arrangement known per se of a premix burner with a swirl generator and a following mixing pipe;

FIG. 2 shows in a representation comparable to FIG. 1 a burner arrangement according to a first exemplary embodiment of the invention, and

FIG. 3 shows in a representation comparable to FIG. 1 a burner arrangement according to a second exemplary embodiment of the invention.

### DETAILED DESCRIPTION OF THE PREFERRED EMBODIMENTS

### Introduction to the Embodiments

The object of the invention is to provide a burner arrangement which permits safe, clean premixing operation with highly reactive fuels, in particular those containing H₂.

The object is achieved by the features of claim 1 in their entirety. Essential for the invention is a mixing pipe which has a constriction, spraying device for spraying in highly reactive, in particular H₂ rich, fuel being provided at the level of the constriction. Taking as a basis the aforementioned conical form of the mixing pipe, in the case of which the throat is arranged at the outlet of the pipe, the throat (as a constriction) may be displaced upstream. The highly reactive fuel is then sprayed in directly at the throat.

One refinement of the invention is that the mixing pipe narrows conically in a first mixing pipe portion, from the swirl generator to the constriction, and that the mixing pipe then becomes much smaller in diameter in a second mixing pipe portion, from the constriction to the combustion chamber, than is the case at the outlet of the swirl generator.

The second mixing pipe portion, beginning at the constriction, may in this case have a constant diameter up to the combustion chamber. The second mixing pipe portion may, however, also slightly widen conically up to the combustion chamber.

It has in this respect proven to be favorable for safe combustion if the constriction is arranged in a middle region of the mixing pipe.

According to another refinement, the spraying device for spraying in highly reactive, in particular H₂-rich, fuel comprise nozzles arranged in the region of the constriction, which undertake feeding of the fuel.

As far as the configuration of the premix burner is concerned, it is quite possible to provide it without a transitional portion between the swirl generator and the mixing pipe. Such a premix burner is disclosed by EP0321809 A1, which corresponds to U.S. Pat. No. 4,932,861, which is incorporated by reference as if fully set forth.

A further refinement of the premix burner envisages providing in a transitional region between the swirl generator and the mixing pipe transitional channels for transferring a swirling flow formed in the swirl generator into the flow cross section of the mixing pipe arranged downstream of these transitional channels. Such a refinement is disclosed by EP0704657 A1, which corresponds to U.S. Pat. No. 5,588,826, which is also incorporated by reference as if fully set forth.

A further refinement of the premix burner envisages providing a cylindrical or quasi-cylindrical pipe which comprises part-shells and into which the combustion air stream flows into the interior space by way of tangentially arranged air inlet slits or channels. The desired swirl formation of the combustion air stream to maximize the desired premixing with at least one fuel sprayed in at a suitable location is achieved, or helped to accomplish, by an inner body extending conically or quasi-conically in the direction of flow. Such a refinement is disclosed, for example, by EP0777081A1, which corresponds to U.S. Pat. No. 5,791,894, which is also incorporated by reference as if fully set forth.

The burner arrangement according to the invention is used with advantage for operating a gas turbine installation with at least one combustion chamber.

Exemplary embodiments of the invention are explained in more detail below with reference to the drawings. All features that are not essential for the direct understanding of the invention have been omitted. The same elements are provided with the same designations in the various figures. The direction of flow of the various media is indicated by arrows.

The exemplary embodiments serve to illustrate the invention and should not be used in a restrictive way when interpreting the subject matter afforded protection as it is defined on the basis of the claims.

### DETAILED DESCRIPTION

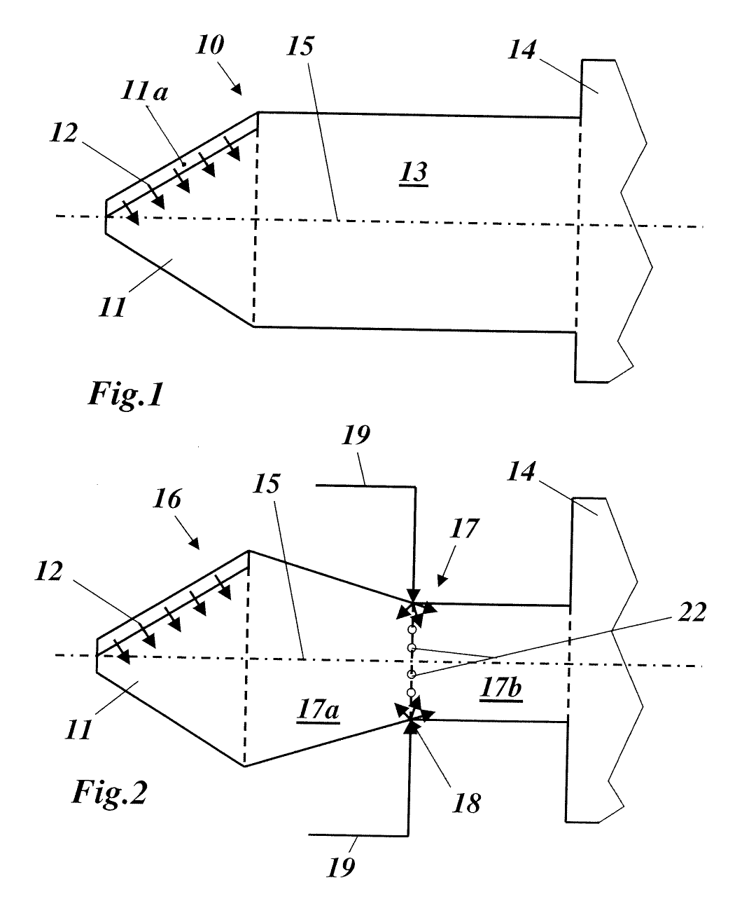

A burner arrangement according to the first exemplary embodiment of the invention is reproduced in FIG. 2 in a representation corresponding to FIG. 1. The burner arrangement 16 comprises a premix burner 11, the form of which is disclosed by the aforementioned document EP 0321809 A1. The air flowing tangentially into the interior of the premix burner 11 is enriched with a fuel, and the swirling movement forming there produces a mixture 12. The premix burner 11 is followed downstream by a mixing pipe 17, which is subdivided into two mixing pipe portions 17a and 17b (of approximately the same length in this example). Formed between the two mixing pipe portions 17a, 17b is a constriction 18. In the first mixing pipe portion 17a, from the premix burner 11 to the constriction 18, the mixing pipe 17 narrows conically or quasi-conically. In the second mixing pipe portion 17b, from the constriction 18 to the combustion chamber 14, the mixing pipe 17 is much smaller in diameter than is the case at the beginning (inlet) of the first mixing pipe portion 17a, having a constant or quasi-constant diameter downstream of said constriction 18. With this configuration, all the advantages of a continuous conical mixing pipe enumerated at the beginning can be achieved, namely:
An increase in the burner speed upstream of the central flowback zone that forms in the region of the outlet of the premix burner, that is to say at the beginning of the combustion chamber 14, whereby the flow dynamics of a flashback into the interior of the premix burner are counteracted.
A reduction in the intensity of the central flowback zone at the burner outlet, whereby the flow dynamics of a flashback into the interior of the premix burner are counteracted.
A displacement of the central flowback zone further downstream of the premix burner, whereby the flow dynamics of a flashback into the interior of the premix burner are counteracted.
Measures to prevent the occurrence and propagation of pulsations that are produced by perturbations in the feeding of the combustion air and/or spraying in of the fuel, whereby a flashback into the interior of the premixed burner is likewise counteracted.

At the same time, this configuration (of the constriction displaced upstream) allows a safer (i.e. involving greatly reduced flashback probability) lean premix combustion of highly reactive fuels. The spraying in of the highly reactive fuel is performed by way of fuel feeds 19 and nozzles 22 directly or in the vicinity of the constriction 18 (see the arrows), where the air speeds of the combustion air are greatest.

The cylindrical mixing pipe portion 17b downstream of the restriction 18 with its much reduced diameter provides high air speeds, which prevent a flashback. This portion also at the same time represents the mixing section, which permits good air/fuel mixing at the outlet of the burner arrangement 17. Another important property of this burner arrangement 17 is the utilization of the Venturi effect. The lower static pressure at the constriction 18, i.e. at the location where the fuel is sprayed in, means that it is possible to achieve adequate spraying in and penetration of the fuel with relatively low fuel pressures, whereby operation with costly fuel compression is significantly reduced.

On account of the greater safety, less rarefaction of the fuel with N₂ and/or H₂O is required.

A further advantage is that the premix burner is suitable unchanged for lean standard premix operation with natural gas and oil, as long as it is ensured that the fuel does not accumulate on the walls of the converging first mixing pipe portion 17a. In other words, the burner arrangement 16 according to FIG. 2 permits operation with three (3) fuels (“tri-fuel operation”).

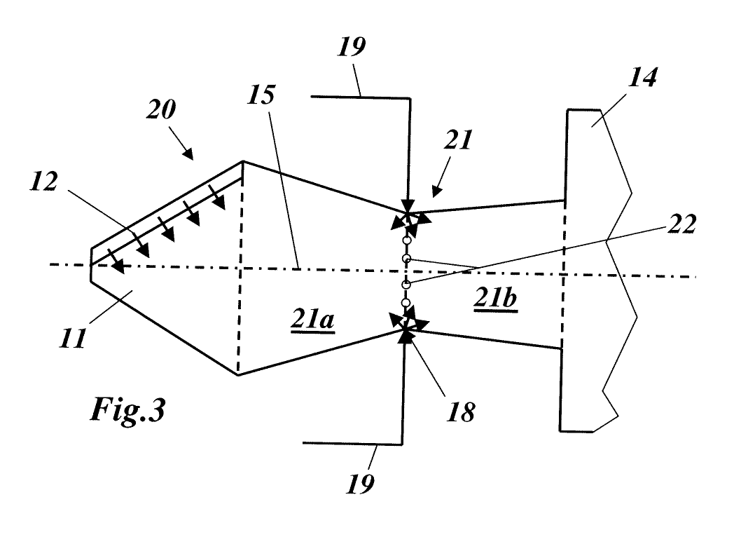

It may, however, also be advantageous, according to FIG. 3, in the case of a burner arrangement 20 with the mixing pipe 21 and the two mixing pipe portions 21a and 21b not to form the rear mixing pipe portion 21b in a cylindrical manner but in a manner slightly widening conically or quasi-conically toward the combustion chamber 14. Such a geometry reduces the tendency of the fuel to accumulate in the direct vicinity of the walls of the mixing portion (21b) and thus increases the resistance to flashback.

It is also advantageous to reduce the pressure difference in the premix burner, in particular in view of the high speeds along the overall length of the mixing pipe.

Advantages are also obtained if an improvement in the radial distribution of the fuel is desired on account of the diverging flow lines.

Burner arrangements according to the invention are particularly suitable for producing hot gas in gas turbine installations in which fuels with a high H₂ content are burned.

### LIST OF DESIGNATIONS

10,16,20 Burner arrangement
11 Premix burner (double cone)
11a Swirl generator
12 Air/fuel mixture (or air)
13 Mixing pipe
14 Combustion chamber
15 Burner axis
17 Mixing pipe
17a,b Mixing pipe portion
18 Constriction
19 Fuel feed
21 Mixing pipe
21a,b Mixing pipe portion
22 Nozzle

What is claimed is:

1. A burner arrangement for operating a premix burner for at least one fuel, the premix burner comprising a swirl generator or is equipped with a swirl generator at a head portion, a fuel feeder and combustion air stream feeder, at least into the swirl generator, the burner arrangement comprising at least one mixing pipe which extends into a combustion chamber acting downstream of the premix burner or swirl generator, wherein the mixing pipe (17, 21) has, downstream of the swirl generator (11a) associated with the premix burner (11), a cross-sectional constriction (18), and a fuel feeder (19, 22) for spraying in a highly reactive fuel (19) arranged in the region of the constriction (18).

2. The burner arrangement as claimed in claim 1, wherein the highly reactive fuel is an H₂-rich fuel.

3. The burner arrangement as claimed in claim 1, wherein a cross section of the mixing pipe (17, 21) narrows conically in a first mixing pipe portion (17a, 21a), from an outlet of the premix burner (11) to the constriction (18).

4. The burner arrangement as claimed in claim 3, wherein the mixing pipe (17, 21) is smaller in cross section in a second mixing pipe portion (17b, 21b), from the constriction (18) to the combustion chamber (14), than the cross section at the outlet of the premix burner (11) in the first mixing pipe portion (17a, 21a).

5. The burner arrangement as claimed in claim 4, wherein the second mixing pipe portion (17b) has a constant cross section.

6. The burner arrangement as claimed in claim 4, wherein the cross section of the second mixing pipe portion (21b) widens conically up to the combustion chamber (14).

7. The burner arrangement as claimed in claim 1, wherein the fuel feeder for spraying in the highly reactive fuel in the region of the constriction (18) takes the form of nozzles (22) arranged there, and the nozzles comprise an associated fuel feed (19).

8. The burner arrangement as claimed in claim 1, wherein the premix burner (11) comprises a swirl generator (11a), which comprises at least two hollow part-cone shells nested one in the other in a direction of flow and define a body, a cross section of an inner space formed by the hollow part-cone shells increases in the direction of flow and the respective axes of longitudinal symmetry of these part-cone shells extend offset in relation to one another in such a way that neighboring walls of the part-cone shells form in a longitudinal extent tangential air inlet slits or channels for a flow of a combustion air stream into the inner space formed by the part-cone shells.

9. The burner arrangement as claimed in claim 1, wherein the swirl generator (11a) comprises at least two hollow part-shells nested one in the other in the direction of flow and make up a body, a cross section of an inner space formed by the hollow part-shells extends cylindrically or quasi-cylindrically in a direction of flow, respective axes of longitudinal symmetry of the part-shells extend offset in relation to one another in such a way that neighboring walls of the part-shells form in a longitudinal extent tangential air inlet slits or channels for a flow of a combustion air into the inner space formed by the part-shells, and the inner space has an inner body of which a cross section decreases conically or quasi-conically in the direction of flow.

10. The burner arrangement as claimed in claim 1, wherein liquid fuel can be introduced by way of a central fuel nozzle (5) and/or gaseous fuel (13) can be introduced at tangential air inlet slits of the respective swirl generator.

11. The burner arrangement as claimed in claim 1, further comprising in a transitional region between the swirl generator (11a) and the mixing pipe (13, 17, 21) transitional channels for transferring a combustion air flow formed in the swirl generator into the flow cross section of the mixing pipe (13, 17, 21) arranged downstream of the transitional channels.

12. A burner arrangement for operating a premix burner for at least one fuel, the premix burner comprising a swirl generator or being equipped with a swirl generator at a head, a fuel feeder and combustion air stream feeder, at least into the swirl generator, the burner arrangement comprising at least one mixing pipe which extends into a combustion chamber acting downstream of the premix burner or swirl generator, wherein the mixing pipe (17, 21) has, downstream of the swirl generator (11a) associated with the premix burner (11), a cross-sectional constriction (18), and a fuel feeder (19, 22) for spraying in a highly reactive fuel (19) arranged in the region of the constriction (18), wherein the burner arrangement is used in a gas turbine installation that can be operated with at least one combustion chamber.

13. The use of the burner arrangement as claimed in claim 12 in a sequentially fired gas turbine installation.

14. The use of the burner arrangement as claimed in claim 12 in a combined installation.
